(19) United States
(12) Patent Application Publication
(10) Pub. No.: US 2019/0362121 A1
(43) Pub. Date: Nov. 28, 2019

(54) OPTICAL DETECTION DEVICE AND DETECTION METHOD THEREOF

(71) Applicant: Au Optronics Corporation, Hsinchu (TW)

(72) Inventors: Chih-Hung Wang, Hsinchu County (TW); Yi-Wei Chen, Hsinchu County (TW); Cheng-Hsiang Ho, Hsinchu County (TW)

(73) Assignee: Au Optronics Corporation, Hsinchu (TW)

(21) Appl. No.: 16/354,197

(22) Filed: Mar. 15, 2019

(30) Foreign Application Priority Data
May 23, 2018 (TW) 107117501

(51) Int. Cl. G06K 9/00

(52) U.S. Cl. CPC G06K 9/0004

(57) ABSTRACT

An optical detection device and a detection method thereof are provided. The optical detection device includes a sensing element array, an optical film layer, a driver and a controller. The sensing element array is used to detect a touching action. The optical film layer covers the sensing element array for receiving the touching action. The controller generates a trigger signal according to the touching action. Wherein, the driver lights the optical film layer according to the trigger event in an initial time interval, and the driver stops the optical film layer being lighted during the interval time interval after the initial time interval and the driver lights the optical film layer again during a detection time interval after the interval time interval, and the optical film layer generates a detecting image according to the touching action. The controller detects the image identification during the detection time interval.

### CROSS-REFERENCE TO RELATED APPLICATION

This application claims the priority benefit of Taiwan application serial no. 107117501, filed on May 23, 2018. The entirety of the above-mentioned patent application is hereby incorporated by reference herein and made a part of this specification.

### BACKGROUND OF THE INVENTION

### 1. Field of the Invention

The present invention relates to an optical detection device and a detection method thereof, in particular, to an optical detection device for fingerprint identification and a detection method thereof.

### 2. Description of Related Art

The current fingerprint identification technology can generally be applied to personal safe boxes, door locks, consumer electronic devices (personal computers, mobile phones, tablet computers), etc. At present, the widely used fingerprint identification technology is mainly optical sensing technology or capacitive sensing technology, and with the maturity of related technologies, the resolution and accuracy of fingerprint identification are further improved.

In a general case, when a user presses a touch surface of a fingerprint identifier through a touch medium (for example, a finger), a residual image (for example, a fingerprint) produced by the touch medium when pressing will be remained on an image displayed on the touch surface. The residual image may cause the problems of decreased accuracy or misjudge and the like when the fingerprint is judged by a detection circuit in the fingerprint identifier.

Hereinafter, please refer to FIG. 1A to FIG. 1C at the same time, FIG. 1A to FIG. 1C are schematic diagrams of an operation process of a conventional fingerprint reader. Wherein, FIG. 1A shows a black screen image (for example, an initial image 110) displayed on the touch surface when there is no touch medium pressing the touch surface of the fingerprint identifier; FIG. 1B shows a fingerprint image 120 that can be captured on the touch surface when a user presses the touch surface through the touch medium (for example, a finger); FIG. 1C shows a residual image 130 displayed on the touch surface of the fingerprint identifier when the finger of the user is removed. It is worth mentioning that, in the prior art, the fingerprint identifier has a certain degree of difference between the dark current Idark1 generated according to the initial image 110 and the dark current Idark2 generated according to the residual image 130, and the difference of the dark current will affect the fingerprint identification action performed by the fingerprint identifier, resulting in a decrease in the accuracy of the fingerprint identification.

### SUMMARY OF THE INVENTION

The present invention provides an optical detection device capable of improving the accuracy of fingerprint identification.

The optical detection device provided by the present invention includes a sensing element array, an optical film layer, a driver and a controller. The sensing element array is used to detect a touching action. The optical film layer covers the sensing element array for receiving the touching action and generating a detecting image according to the touching action. The driver is coupled to the optical film layer. The controller is coupled to the driver and the sensing element array and generates a trigger signal according to the touching action. Wherein, the driver lights the optical film layer according to the trigger event in an initial time interval, and the driver stops the optical film layer being lighted during an interval time interval after the initial time interval and the driver lights the optical film layer again during a detection time interval after the interval time interval. Wherein, the controller detects the image identification during the detection time interval.

An optical detection method provided by the present invention includes the following steps: providing a sensing element array for detecting a touching action; providing an optical film layer for receiving the touching action and generating a detecting image according to the touching action; generating a trigger signal according to the touching action; lighting the optical film layer according to the trigger event in an initial time interval, and stopping the optical film layer being lighted during an interval time interval after the initial time interval and lighting the optical film layer again during a detection time interval after the interval time interval; and detecting the image identification during the detection time interval.

Based on the above, the optical detection device provided by the present invention may utilize the controller to judge whether the touching action detected by the sensing element array occurs or not, if the controller judges that the trigger event occurs in the optical film layer through the touch medium (for example, a finger) by a user, the controller may transmit the trigger signal to the driver according to a sensing value output by the sensing element array, and the driver may determine whether to generate a power voltage to the optical film layer to light or stop lighting the optical film layer. As a result, according to the present invention, the dark current generated before/after the detecting image is lighted may be effectively reduced, thereby reducing the difference between the dark current before and after the detecting image is lighted so as to achieve high-quality image effects.

In order to make the aforementioned and other objectives and advantages of the present invention comprehensible, embodiments accompanied with figures are described in detail below.

### BRIEF DESCRIPTION OF THE DRAWINGS

FIG. 1A to FIG. 1C are schematic diagrams of an operation process of a conventional fingerprint identifier.

FIG. 2 is a schematic diagram illustrating an optical detection device according to an embodiment of the present invention.

FIG. 3 is a schematic diagram of a judging manner of a touching action according to an embodiment of the present invention.

FIG. 4 is a schematic diagram illustrating a time interval of a driver lighting an optical film layer according to an embodiment of the present invention.

FIG. 5 is a flowchart of an optical detection method of an optical detection device according to an embodiment of the present invention.

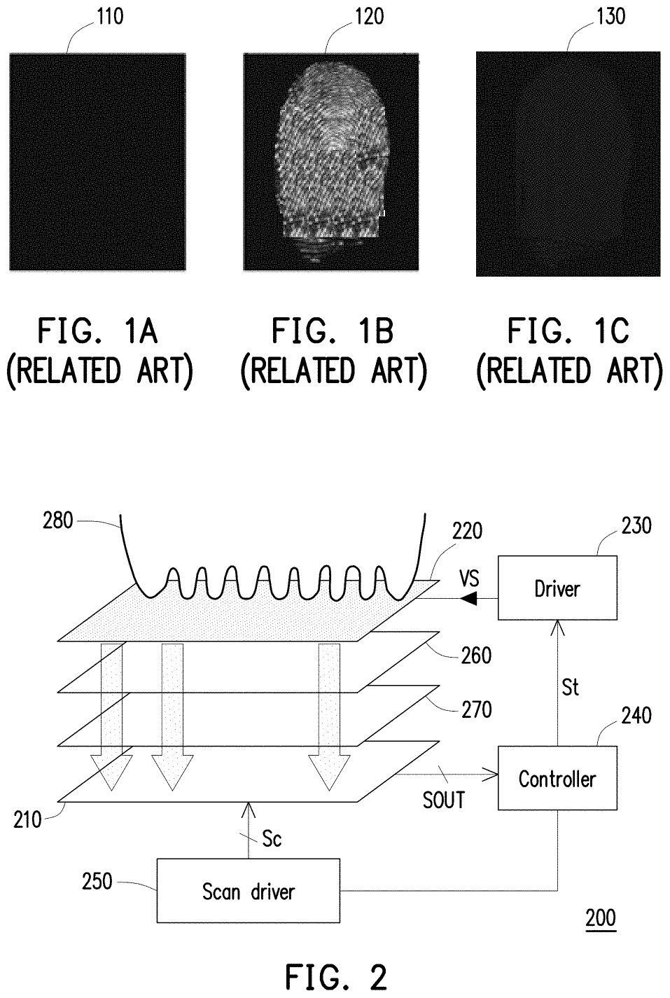

### DESCRIPTION OF THE EMBODIMENTS

FIG. 2 is a schematic diagram illustrating an optical detection device according to an embodiment of the present invention. The optical detection device 200 includes a sensing element array 210, an optical film layer 220, a driver 230, a controller 240, and a scan driver 250. Wherein, the optical film layer 220 covers the sensing element array 210. A transparent conductive film layer 260 and an optical adhesive layer 270 may be included between the optical film layer 220 and the sensing element array 210, so that the conductive film layer 260 and the optical adhesive layer 270 may serve as media for transferring chargers between the optical film layer 220 and the sensing element array 210. Wherein, the conductive film layer 260 of the present embodiment may be, for example, indium tin oxide, but is not limited thereto. In the present embodiment, the driver 230 is coupled to the optical film layer 220, and the driver 230 may be used to provide the power voltage VS to the optical film layer 220.

On the other hand, the sensing element array 210 in the present embodiment has a plurality of scanning lines. The scan driver 250 is coupled to the scanning lines and provides a scanning signal Sc to the scanning lines. The scanning signal Sc is transmitted to the sensing element array 210 through the scanning lines. Wherein, the controller 240 in the present embodiment may be coupled to the driver 230 and the scan driver 250. In addition, the controller 240 is further coupled to the sensing element array 210 and receives a sensing value SOUT sent by the sensing element array 210.

Specifically, in the present embodiment, when a user presses the optical film layer 220 through a touch medium 280 (for example, a finger), based on the grounding effect between the finger of the user and the ground plane and the power voltage VS provided by the driver 230 to the optical film layer 220, the optical film layer 220 may be lighted correspondingly, and the trigger event is initiated. In detail, when the optical detection device 200 in the present embodiment is operated in an initial time interval, the driver 230 continuously supplies the power voltage VS to the optical film layer 220 so that the optical film layer 220 may be lighted in the initial time interval. Then, when an initial time interval after the initial time interval ends, the controller 240 may output the trigger signal St and cause the driver 230 to turn off the power voltage VS according to the trigger signal St to stop the optical film layer 220 being lighted in the interval time interval. Then, when the optical detection device 200 is operated in a detection time interval after the interval time interval, the driver 230 restarts the power voltage VS according to the trigger signal St so that the optical film layer 220 is lighted again. At the same time, the controller 240 may output the sensing value SOUT according to the touching action detected by the sensing element array 210, so as to know that an effective touching action occurs on the optical detection device 200.

It is worth mentioning that in the present embodiment, the sensing element array 210 may have a plurality of scanning lines. During the touch scanning detection process, the scanning driver 250 may allow the scanning lines to perform a scanning action one by one through the scanning signal Sc and complete the scanning action of all scanning lines in a frame cycle.

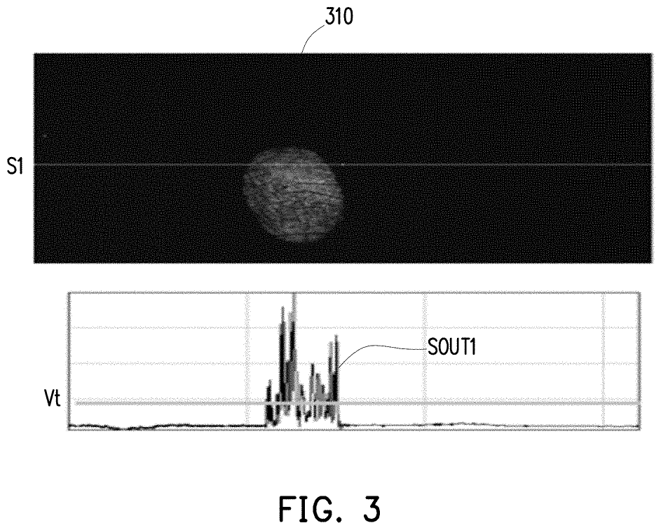

Please refer to FIG. 2 and FIG. 3 at the same time, FIG. 3 is a schematic diagram of a judgement manner of a touching action according to an embodiment of the present invention. In detail, when the optical detection device 200 is operated in a frame cycle, the controller 240 may receive image grayscale values respectively corresponding to the scanning lines on the sensing element array 210. As shown in an image 310, when the user presses the optical film layer 220 through the finger, a residual image 310 (for example, a fingerprint) may be generated on the optical film layer 220. When the scanning lines Si perform the scanning action, the sensing element array 210 may generate a corresponding sensing value SOUT1. The controller 240 may allow the sensing value SOUT1 to judge whether the effective touching action occurs on the optical film layer 220 or not according to a comparison between the image grayscale value in the residual image 310 and a preset threshold value Vt, and according to the width of the distribution range of the sensing value SOUT1 greater than the threshold value Vt.

Further, since the scan driver 250 may scan the grayscale value of each region in the residual image 310 by utilizing the scanning lines S1, and the image 310 may form a detection waveform according to the distance between pixels and the corresponding image grayscale values. Therefore, the controller 240 in the present embodiment may perform Binary conversion processing on the image grayscale values in the image 310, and may detect the widths of peaks and troughs in the detection waveform. That is, the controller 240 may judge whether the optical film layer 220 is touched or not according to the binary conversion result and the widths of the peaks and troughs in the detection waveform. For example, if the controller 240 judges that the result of the image grayscale value in the image 310 after binary conversion is high logic (for example, logic 1), it shows that the image grayscale value of the region of the image 310 scanned by the scanning lines Si is greater than the threshold value Vt, that is, the controller 240 judges that the touching action occurs. On the contrary, if the controller 240 judges that the result of the image grayscale value in the image 310 after binary conversion is low logic (for example, logic 0), it shows that the image grayscale value of the region of the image 310 scanned by the scanning lines 51 is not greater than the threshold value Vt, that is, the controller 240 judges that the touching action does not occur.

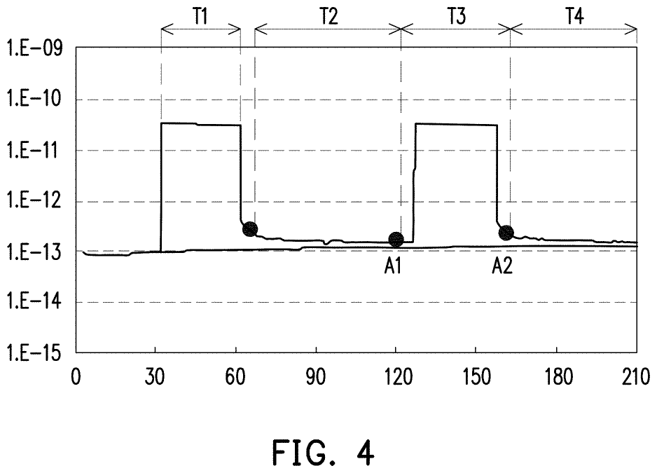

FIG. 4 is a schematic diagram illustrating a time interval of a driver lighting an optical film layer according to an embodiment of the present invention. Hereinafter, please refer to FIG. 2 and FIG. 4 at the same time, in detail, when the optical detection device 200 is operated in the initial time interval T1, and the user presses the optical film layer 220 through the touch medium 280 (for example, a finger or any other tool or product having a touch function), the trigger event may be initiated. When the trigger event occurs, the optical film layer 220 may be correspondingly lighted based on the grounding effect between the finger of the user and the ground plane and the power voltage VS provided by the driver 230 to the optical film layer 220. Then, when an initial time interval after the initial time interval T1 during which the optical detection device 200 is operated ends, the controller 240 may generate a disabled (for example, low voltage level) trigger signal St to the driver 230 and allow the driver 230 to turn off the power voltage VS according to the trigger signal St so as to stop the optical film layer 220 being lighted in the interval time interval T2.

On the other hand, when the optical detection device 200 is operated in a detection time interval T3 after the interval time interval T2, the controller 240 may know that an effective touching action occurs on the optical film layer 220 according to the sensing value SOUT so as to generate an enabled (for example, high voltage level) trigger signal St to the driver 230, and the driver 230 may restart the power voltage VS according to the trigger signal St so as to allow the optical film layer 220 to be lighted again, and correspondingly generate a detecting image. In addition, when the optical detection device 200 is operated in a standby time interval T4 after the detection time interval T3, the controller 240 may generate a disabled (for example, low voltage level) trigger signal St again so that the driver 230 turns off the power voltage VS again in the standby time interval T4 to stop the optical film layer 220 being lighted. It is particularly noted that in the present embodiment, when the optical detection device 200 is operated in the detection time interval T3, the optical detection device 200 may utilize the controller 240 to perform an identification action on the detecting image generated by the optical film layer 220.

It is worth mentioning that, in the present embodiment, whether the optical detection device 200 is operated in the initial time interval T1 or operated in the detection time interval T3 or not, the brightness of the optical film layer 220 in the present embodiment is the same. Similarly, whether the optical detection device 200 is operated in the interval time interval T2 or operated in the standby time interval T4 or not, the brightness of the optical film layer 220 in the present embodiment is substantially the same. In addition, the time lengths of the initial time interval T1, the interval time interval T2, and the detection time interval T3 are not fixedly limited, and the time lengths of the initial time interval T1, the interval time interval T2, and the detection time interval T3 may be set according to the material characteristics of the optical detection device 200 by designers.

It is worth mentioning that, in the present embodiment, the sizes of dark current detected by the optical film layer 220 are quite close at the time point A1 and the time point A2. That is to say, according to the optical detection device 200 in the embodiment of the present invention, through the mechanism for lighting the optical film layer 220 twice, the difference between the dark current generated by the optical detection device 200 at the time point A2 and the dark current at the time point A1 before the optical film layer 220 is lighted for the second time is further reduced, thereby improving the accuracy of fingerprint identification.

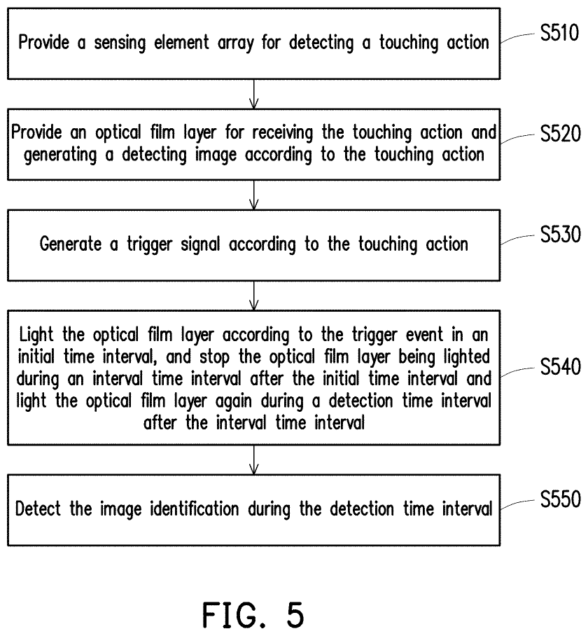

FIG. 5 is a flowchart of an optical detection method of an optical detection device according to an embodiment of the present invention. In step S510, the optical detection device may provide the sensing element array for detecting the touching action. In step S520, the optical detection device may provide the optical film layer to receive the touching action and generate a detecting image according to the touching action. In step S530, the controller may generate the trigger signal according to the touching action. In step S540, the driver may light the optical film layer according to the trigger event in the initial time interval, and the driver may stop the optical film layer being lighted during the interval time interval after the initial time interval and the driver may light the optical film layer again during a detection time interval after the interval time interval. And, the optical film layer may generate the detecting image when it is lighted for the second time. In step S550, the controller detects the image identification during the detection time interval.

The implementation details of each step are described in detail in the foregoing embodiments and examples, and the descriptions thereof are omitted herein.

Based on the above, according to the optical detection device provided by the present invention, through the mechanism of lighting the optical film layer twice, the difference between the dark current generated before and after the optical film layer is lighted may be further reduced, thereby improving the accuracy of fingerprint identification.

Although the present invention has been disclosed by the embodiments above, it is not intended to limit the present invention. Any person having ordinary skill in the art may make some changes and modifications without departing from the spirit and scope of the present invention. Thereof, the scope of protection of the present invention shall be subject to the definition of the appended claims.

What is claimed is:

1. An optical detection device, comprising:
a sensing element array, used to detect a touching action;
an optical film layer, covering the sensing element array for receiving the touching action;
a driver, coupled to the optical film layer; and
a controller, coupled to the driver and the sensing element array and generating a trigger signal according to the touching action,
wherein, the driver lights the optical film layer according to a trigger event in an initial time interval, and the driver stops the optical film layer being lighted during an interval time interval after the initial time interval and the driver lights the optical film layer again during a detection time interval after the interval time interval, and the optical film layer generates a detecting image according to the touching action,
wherein, the controller identifies the detecting image during the detection time interval.

2. The optical detection device according to claim 1, wherein, the sensing element array comprises a plurality of scanning lines, and the controller sequentially drives the scanning lines to detect whether the touching action occurs or not in a frame cycle.

3. The optical detection device according to claim 2, wherein in the frame cycle, the controller receives at least one image grayscale value respectively corresponding to at least one of the scanning lines on the sensing element array, and judges whether the touching action occurs or not according to a comparison between the at least one image grayscale value and a threshold value.

4. The optical detection device according to claim 3, wherein when the at least one image grayscale value is greater than the threshold value, the controller judges that the touching action occurs.

5. The optical detection device according to claim 1, wherein, when the controller judges that the touching action occurs, the controller generates the enabled trigger signal.

6. The optical detection device according to claim 1, wherein in the initial time interval, the brightness of the optical film layer and the brightness of the optical film layer in the detection time interval are the same.

7. The optical detection device according to claim 1, wherein the controller stops the optical film layer being lighted during a standby time interval after the detection time interval,
wherein the brightness of the optical film layer in the interval time interval and the brightness of the optical film layer in the standby time interval are substantially the same.

8. An optical detection method, comprising:
providing a sensing element array for detecting a touching action;
providing an optical film layer for receiving the touching action;
generating a trigger signal according to the touching action;
lighting the optical film layer according to a trigger event in an initial time interval, and stopping the optical film layer being lighted during an interval time interval after the initial time interval and lighting the optical film layer again during a detection time interval after the interval time interval, and the optical film layer generating a detecting image according to the touching action; and
identifying the detecting image during the detection time interval.

9. The optical detection method according to claim 8, wherein a step of providing the sensing element array for detecting the touching action comprises:
sequentially driving a plurality of scanning lines of the sensing element array to detect whether the touching action occurs or not in a frame cycle.

10. The optical detection method according to claim 9, wherein a step of detecting whether the touching action occurs or not in the frame cycle comprises:
receiving at least one image grayscale value respectively corresponding to at least one of the scanning lines on the sensing element array; and
judging whether the touching action occurs or not according to a comparison between the at least one image grayscale value and a threshold value.

11. The optical detection method according to claim 10, wherein a step of judging whether the touching action occurs or not according to the comparison between the at least one image grayscale value and the threshold value comprises:
when the at least one image grayscale value is greater than the threshold value, judging that the touching action occurs.

12. The optical detection method according to claim 11, further comprising:
when judging that the touching action occurs, generating the enabled trigger signal.

13. The optical detection method according to claim 8, wherein in the initial time interval, the brightness of the optical film layer and the brightness of the optical film layer in the detection time interval are the same.

14. The optical detection method according to claim 8, further comprising:
stopping the optical film layer being lighted during a standby time interval after the detection time interval,
wherein the brightness of the optical film layer in the interval time interval and the brightness of the optical film layer in the standby time interval are substantially the same.
